(19) United States
(12) Patent Application Publication
(10) Pub. No.: US 2011/0196055 A1
(43) Pub. Date: Aug. 11, 2011

(54) PROCESS FOR THE PREPARATION OF CLOSED CELL RIGID POLYURETHANE FOAMS

(75) Inventors: Hans Kramer, Kempraten-Jona (CH); Vanni Parenti, Campagnola (IT)

(73) Assignee: Dow Global Technologies LLC, Midland, MI (US)

(21) Appl. No.: 13/122,523

(22) PCT Filed: Oct. 20, 2009
(86) PCT No.: PCT/EP09/63736

§ 371 Date: Apr. 4, 2011

(30) Foreign Application Priority Data
Oct. 22, 2008 (IT) MI2008A001867

(51) Int. Cl. C08J 9/12; C08G 18/18; C08G 18/20; C08G 18/22; C08G 18/24

(52) U.S. Cl. 521/93; 521/170; 521/164; 521/94

(57) ABSTRACT

A process for preparing a cavity-filling, fast-gelling closed cell rigid polyurethane foam comprises preparing a formulation including at least a polyisocyanate, a relatively high viscosity polyol system including at least about 10 percent by weight of an amine-initiated polyol, a physical blowing agent, a blowing catalyst and a curing catalyst, and, optionally, less than about 1.6 weight percent of water based on the polyol system. Other conventional components, such as a chain extender and/or crosslinker, surfactant, and the like may also be included. The formulation is injected under a reduced atmospheric pressure to achieve a closed cell, rigid polyurethane foam having a density of less than about 40 kg/m³, an average cell diameter of less than about 250 microns, and a thermal conductivity of less than about 19 mW/mK at 10° C. average plate temperature.

### BACKGROUND OF THE INVENTION

1. Technical Field

This invention relates to formulations and processes to make closed cell rigid polyurethane foams. More particularly, it relates to processes to make fast-reacting, low density polyurethane foams that may be used for, in particular, appliance insulation.

2. Background of the Art

One of the most commercially important applications for rigid polyurethane foams is in the appliance industry. In this application the foams supply insulation from heat and/or cold, and may also serve to increase structural integrity and/or strength of the appliance. Frequently the foams are part of composite, sandwich-type constructions wherein at least one outer layer of a rigid or elastic material, such as, for example, paper, plastic film, rigid plastics, metal sheeting, glass nonwoven materials, chipboard, and the like is also included. In particular applications, such as refrigerators, freezers, hot water storage tanks, and pipe in pipe, the components of the rigid polyurethane foam may be injected into cavities, wherein the components first fill the cavity and then complete reaction to form the final rigid polyurethane foam. In order to ensure the necessary characteristics of the final foam in cavity-filling applications, it is particularly desirable to complete introduction of the foam-forming components within a relatively short time.

Substantial research has been carried out to develop foam-forming polyurethane systems for these applications. For example, an overview of this technology, and particularly use of rigid polyurethane foams as layers in composite elements as well as use as the insulating layer in refrigeration or heating technology may be found in Polyurethanes, Kunststoff-Handbuch, volume 7, 1^{st} ed. 1966, ed. Dr. R. Vieweg and Dr. A. Hachtlen, and 2d ed. 1983, ed. Dr. G. Oertel, Carl Hanser Verlag.

In general, heat- and cold-insulating rigid polyurethane foams may be produced by reacting organic polyisocyanates with one or more relatively high viscosity compounds containing at least two reactive hydrogen atoms, such as polyester- and/or polyether-polyols, usually in the presence of low molecular weight chain extenders and/or cross-linking agents, in the presence of blowing agents and catalysts. If desired, auxiliaries and/or additives may be further included. Choice of appropriate components enables production of rigid polyurethane foams having acceptably low thermal conductivity and desirable mechanical properties.

For example, Canadian Patent 2,161,065 discloses use of a formulation including components that contain, alone or in combination, at least 32 percent by weight of aromatic radicals. It is asserted therein that the relatively high aromaticity of the formulation serves to improve the insulating performance (thermal conductivity) by at least 0.5 mW/mK, and also improves flame resistance and aging behavior of the foams.

Selection of blowing agents has often been problematic. This is because, while chlorofluorocarbons (CFCs) have long been known to perform well in insulating foams, their use is progressively more restricted by law for environmental reasons. Thus, a body of art has arisen with the goal of reducing or eliminating CFC use while still achieving, or attempting to achieve, desirable insulation and mechanical performance. This is particularly important because, as a general rule, the blowing agent remains in the rigid polyurethane foam for a considerable time as a cell gas. Thus, the cell gas itself, and not just the foam matrix, provides a very significant portion of the overall insulation performance of the foam. This is particularly so in applications such as appliances, where the generally very slow diffusion rate of the gas out of the cells is further slowed, or virtually prevented, by encasement of the foam in plastic or metal outer layer(s).

For example, U.S. Pat. No. 4,972,002 shows use of fluorinated hydrocarbons wherein the limited solubility thereof in typical rigid polyurethane formulations is compensated for by emulsifying the fluorinated hydrocarbon in at least one of the components. Another patent, DE-A-41 42 148, discloses a combination of a fluorinated compound with at least one isoalkane.

Another approach that has been widely used is inclusion of water as at least a portion of the blowing agent. For example, U.S. Pat. No. 5,096,933 discloses cyclopentane or mixtures of cyclopentane and/or cyclohexane with an inert, low-boiling compound which is homogeneously miscible with cyclopentane and/or cyclohexane. These agents are preferably combined with water to achieve the desired degree of foam formation.

While selection of components of a foam-forming formulation is, as discussed hereinabove, important in determining the insulating capability of a final rigid poly- urethane foam, those skilled in the art have also had to address process-related issues, particularly as they relate to how processing variations affect the insulating and mechanical capabilities of the foams. Achieving optimum foam density, cell size, and especially uniformity, while also ensuring excellent cavity-filling or mold-filling performance, has challenged the industry to search for new ways to introduce the formulation components. For example, introduction may be achieved by single shot injection, simultaneous injection at multiple sites, positional variations of the mold or of a “cabinet,” i.e., the container having the cavity that is destined to be filled by the polyurethane foam, and the like. The speed of movement of the formulation throughout the cavity relative to the rate of reaction may also be an important factor. The faster the foam gelation, the shorter is the gel (or string) time; hence it is more challenging to fill the cavity without voids due to the fast viscosity build-up of reactants.

Use of polyurethane foaming under reduced pressure is known. For example, U.S. Pat. No. 5,439,945 discloses water-blown “high density” foams, normally having densities in the range of 200 kg/m³, prepared using a vacuum to bring down the density to 100 kg/m³. A publication, WO 2007/058793, describes a method of molding rigid polyurethane foams wherein a density/lambda (density/thermal insulation) ratio of 1.65 to 2.15 is achieved under a pressure of 300 to 950 mbar and a packing factor of 1.03 to 1.9. Still another example may be found in U.S. Pat. No. 5,439,945 A, which discloses foams that are prepared under a reduced pressure and subsequently encased in a material which prevents ambient air from entering the cell voids. The gas within the foam reaches equilibrium at a lesser pressure than in prior systems.

Unfortunately, many of the above-described inventions are relatively expensive; may require retooling on a production line; suffer from relatively poor cavity-filling or mold-filling capability; are limited to densities that are higher than desired; suffer relatively poor mechanical properties; and the like. In view of this, and despite the multitude of approaches to these problems, there remains a need in the art for a formulation and/or process that enables efficient, cost-effective production of closed cell rigid polyurethane foams that attain desirable molded densities and insulation factors while filling a cavity without voids and at the same time offering good mechanical properties and fast demoldability, whether such foams are to be used as molded products or as cavity-filling products.

### SUMMARY OF THE INVENTION

Accordingly, the present invention provides, in one aspect, a process for preparing a cavity-filling closed cell rigid polyurethane foam comprising (a) preparing a reactive foam-forming system comprising as components at least a polyisocyanate; a polyol system containing at least about 10 percent by weight of an amine-initiated polyol and having a viscosity of at least about 5,000 centipoise (cP) at 25° C., according to ASTM D445; a non-chlorofluorocarbon physical blowing agent; a blowing catalyst; a curing catalyst; and, optionally, an amount of water that is less than about 1.6 percent by weight based on the polyol system; (b) injecting the reactive foam-forming system under a reduced atmospheric pressure into a cavity, wherein the reactive foam-forming system forms a gel in no more than about 25 seconds; and (c) maintaining the reduced atmospheric pressure at least until the gel forms a closed cell rigid polyurethane foam, the foam having a density of less than about 40 kg/m³, an average cell diameter of less than about 250 microns, and a thermal conductivity of less than about 19 mW/mK at 10° C. average plate temperature, according to ISO 12939/DIN 52612.

### DETAILED DESCRIPTION OF THE INVENTION

The invention provides a formulation and a process whereby a closed cell rigid polyurethane foam that shows particular utility in insulation applications, and particularly in molded and cavity-filling applications. Such applications include, for example, pipe in pipe, appliances, such as refrigerators, freezers, hot water storage tanks, and the like. In applications highly driven by energy efficiency, such as refrigerators and freezer, the application of closed cell rigid polyurethane foam may be combined with the use of vacuum insulation panels (VIP) in the structure.

The formulation is similar to other polyurethane formulations in that it includes an organic polyisocyanate. Suitable polyisocyanates may be aliphatic, cycloaliphatic, araliphatic, aromatic polyisocyanates, or combinations thereof. Such may include, for example, alkylene diisocyanates, particularly those having from 4 to 12 carbon atoms in the alkylene moiety, such as 1,12-dodecane diisocyanate, 2-ethyltetramethylene 1,4-diisocyanate, 2-methyl-pentamethylene 1,5-diisocyanate, 2-ethyl-2-butylpentamethylene 1,5-diisocyanate, tetramethylene 1,4-diisocyanate and preferably hexamethylene 1,6-diisocyanate;

cycloaliphatic diisocyanates, such as cyclohexane 1,3- and 1,4-diisocyanate and any desired mixture of these isomers, 1- isocyanato-3,3,5-trimethyl-5-isocyanato-methylcyclohexane (isophorone diisocyanate), 2,4- and 2,6-hexahydrotolylene diisocyanate, and the corresponding isomer mixtures, 4,4-, 2,2′- and 2,4′-dicyclohexylmethane diisocyanate and the corresponding isomer mixtures, araliphatic diisocyanates, e.g., 1,4-xylylene diisocyanate and xylylene diisocyanate isomer mixtures, and preferably aromatic diisocyanates and polyisocyanates, e.g., 2,4- and 2,6-tolylene diisocyanate and the corresponding isomer mixtures, 4,4′-, 2,4′- and 2,2′-diphenylmethane diisocyanate and the corresponding isomer mixtures, mixtures of 4,4′- and 2,4′-diphenylmethane diisocyanates, polyphenyl-polymethylene polyisocyanates, mixtures of 4,4′-, 2,4′- and 2,2′-diphenylmethane diisocyanates and polyphenyl-polymethylene polyisocyanates (crude MDI), and mixtures of crude MDI and tolylene diisocyanates. The organic diisocyanates and polyisocyanates may be employed individually or in the form of combinations thereof.

The organic polyisocyanates may be prepared by known processes. They are preferably prepared by phosgenation of the corresponding polyamines with formation of polycarbamoyl chlorides and thermolysis thereof to give the organic polyisocyanate and hydrogen chloride, or by phosgene-free processes, such as for example by reacting the corresponding polyamines with urea and alcohol to give polycarbamates, and thermolysis thereof to give the polyisocyanate and alcohol.

Modified polyisocyanates may also be used, that is, products which are obtained by chemical reaction of organic diisocyanates and/or polyisocyanates. Specific examples are ester-, urea-, biuret-, allophanate-, uretoneimine-, carbodiimide-, isocyanurate-, uretdione- and/or urethane-containing diisocyanates and/or polyisocyanates. Individual examples are urethane-containing organic, preferably aromatic, polyisocyanates containing from 33.6 to 15 percent by weight, preferably from 31 to 21 percent by weight, of NCO, based on the total weight. Examples include 4,4′-diphenylmethane diisocyanate, 4,4′- and 2,4′-diphenylmethane diisocyanate mixtures, or crude MDI or 2,4- or 2,6 -tolylene diisocyanate, in each case modified by means of low molecular weight diols, triols, dialkylene glycols, trialkylene glycols or polyoxyalkylene glycols having molecular weight of up to about 6,000. Specific examples of di- and polyoxyalkylene glycols, which may be employed individually or as mixtures, are diethylene, dipropylene, polyoxyethylene, polyoxypropylene and polyoxy-propylene-polyoxyethylene glycols, triols and/or tetrols. NCO-containing prepolymers containing from 25 to 3.5 percent by weight, preferably from 21 to 14 percent by weight, of NCO, based on the total weight, and prepared from the polyester- and/or preferably polyether-polyols described hereinbelow and 4,4′-diphenylmethane diisocyanate, mixtures of 2,4′- and 4,4′-diphenylmethane diisocyanate, 2,4- and/or 2,6-tolylene diisocyanates or crude MDI are also suitable. Furthermore, liquid polyisocyanates containing carbodiimide groups and/or isocyanurate rings and containing from 33.6 to 15 percent by weight, preferably from 31 to 21 percent by weight, of NCO, based on the total weight, e.g., based on 4,4′-, 2,4′- and/or 2,2′-diphenylmethane diisocyanate and/or 2,4′ and/or 2,6-tolylene diisocyanate, may also prove successful.

The modified polyisocyanates may be mixed with one another or with unmodified organic polyisocyanates, e.g., 2,4′- or 4,4′-diphenylmethane diisocyanate, crude MDI, and/or 2,4- and/or 2,6-tolylene diisocyanate.

Organic polyisocyanates which may also be particularly successful may further include mixtures of modified organic polyisocyanates containing urethane groups, having an NCO content of from 33.6 to percent by weight, in particular those based on tolylene diisocyanates, 4,4′-diphenylmethane diisocyanate, diphenylmethane diisocyanate isomer mixtures or crude MDI, in particular 4,4′-, 2,4′- and 2,2′-diphenylmethane diisocyanate, polyphenyl-polymethylene polyisocyanates, 2,4- and 2,6-tolylene diisocyanate, crude MDI having a diphenylmethane diisocyanate isomer content of from about 30 to about 80 percent by weight, preferably from about 35 to about 45 percent by weight, and mixtures of at least two of the above-indicated polyisocyanates, for example, crude MDI or mixtures of tolylene diisocyanates and crude MDI.

The second listed major component of the foam-forming formulation is a polyol system comprising at least about 10 percent by weight of an amine-initiated polyol that contains at least two reactive hydrogen atoms. This polyol generally has a functionality of from 2 to 8, preferably 3 to 8, and an average hydroxyl number preferably from about 200 to about 850, preferably from about 300 to about 770. Amine initiated polyols, due to the presence of nitrogen atoms, may have catalytic activity, mainly with respect to foam curing, and may have an influence on the blowing reaction. The polyol system has a viscosity at 25° C. of at least about 5,000 cP, as measured according to ASTM D455, meaning it is a relatively viscous material prior to contacting the other components of the foam-forming formulation. In some embodiments, a higher viscosity, of at least about 6,000 cP, may be preferable. An upper viscosity limit may be dictated by practicality and equipment limitations, but for most purposes a polyol system viscosity of less than about 20,000 cP, and more typically 15,000 cP, is generally suitable.

Examples of other polyols which may be included in the system are polythio-ether-polyols, polyester-amides, hydroxyl-containing polyacetals and hydroxyl-containing aliphatic polycarbonates, and preferably polyester-polyols and polyether-polyols. Other selections may include mixtures of at least two of the above-mentioned polyhydroxyl compounds and with polyhydroxyl compounds having hydroxyl numbers of less than 100.

Suitable polyester-polyols may be prepared from, for example, organic dicarboxylic acids having from about 2 to about 12 carbon atoms, preferably aromatic dicarboxylic acids having from 8 to 12 carbon atoms and polyhydric alcohols, preferably diols having from 2 to 12 carbon atoms, preferably from 2 to 6 carbon atoms. Examples of suitable dicarboxylic acids are succinic acid, glutaric acid, adipic acid, suberic acid, azelaic acid, sebacic acid, decanedicarboxylic acid, maleic acid, fumaric acid, and preferably phthalic acid, isophthalic acid, terephthalic acid and the isomeric naphthalene-dicarboxylic acids. The dicarboxylic acids may be used either individually or mixed with one another. The free dicarboxylic acids may also be replaced by the corresponding dicarboxylic acid derivatives, for example, dicarboxylic esters of alcohols having 1 to 4 carbon atoms or dicarboxylic anhydrides. Preference is given to dicarboxylic acid mixtures comprising succinic acid, glutaric acid and adipic acid in ratios of, for example, from 20 to 35:35 to 50:20 to 32 parts by weight, and adipic acid, and in particular mixtures of phthalic acid and/or phthalic anhydride and adipic acid, mixtures of phthalic acid or phthalic anhydride, isophthalic acid and adipic acid or dicarboxylic acid mixtures of succinic acid, glutaric acid and adipic acid and mixtures of terephthalic acid and adipic acid or dicarboxylic acid mixtures of succinic acid, glutaric acid and adipic acid. Examples of dihydric and polyhydric alcohols, in particular diols, are ethanediol, diethylene glycol, 1,2- and 1,3-propanediol, dipropylene glycol, 1,4-butanediol, 1,5-pentanediol, 1,6-hexanediol, 1,10-decanediol, glycerol, trimethylolpropane. Preference is given to ethanediol, diethylene glycol, 1,4-butanediol, 1,5-pentanediol, 1,6-hexanediol or mixtures of at least two of said diols, in particular mixtures of 1,4-butanediol, 1,5-pentanediol and 1,6-hexanediol. Furthermore, polyester-polyols made from lactones, e.g., ε-caprolactone or hydroxycarboxylic acids, e.g., ω-hydroxycaproic acid and hydrobenzoic acid, may also be employed.

The polyester-polyols may be prepared by polycondensing the organic, e.g., aliphatic and preferably aromatic polycarboxylic acids and mixtures of aromatic and aliphatic polycarboxylic acids, and/or derivatives thereof, and polyhydric alcohols without using a catalyst or preferably in the presence of an esterification catalyst, expediently in an inert gas atmosphere, e.g., nitrogen, carbon monoxide, helium, argon, inter alia, in the melt at from about 150 to about 250° C., preferably from 180 to 220° C., at atmospheric pressure or under reduced pressure until the desired acid number, which is advantageously less than 10, preferably less than 2, is reached. In a preferred embodiment, the esterification mixture is polycondensed at the abovementioned temperatures under atmospheric pressure and subsequently under a pressure of less than 500 mbar, preferably from 50 to 150 mbar, until an acid number of from 80 to 30, preferably from 40 to 30, has been reached. Examples of suitable esterification catalysts are iron, cadmium, cobalt, lead, zinc, antimony, magnesium, titanium and tin catalysts in the form of metals, metal oxides or metal salts. However, the polycondensation may also be carried out in the liquid phase in the presence of diluents and/or entrainers, e.g., benzene, toluene, xylene or chlorobenzene, for removal of the water of condensation by azeotropic distillation.

The polyester-polyols are advantageously prepared by polycondensing the organic polycarboxylic acids and/or derivatives thereof with polyhydric alcohols in a molar ratio of from 1:1 to 1:1.8, preferably from 1:1.05 to 1:1.2. The polyester-polyols preferably have a functionality of from 2 to 3 and a hydroxyl number of from 150 to 600, in particularly, from 200 to 400.

However, the polyhydroxyl compounds used are in particular polyether-polyols prepared by known processes, for example, by anionic polymerization using alkali metal hydroxides such as sodium hydroxide or potassium hydroxide, or alkali metal alkoxides, such as sodium methoxide, sodium ethoxide, potassium ethoxide or potassium isopropoxide as catalyst and with addition of at least one initiator molecule containing from 2 to 8, preferably 3 to 8, reactive hydrogen atoms in bound form or by cationic polymerization using Lewis acids, such as antimony pentachloride, boron fluoride etherate, inter alia, or bleaching earth as catalysts, from one or more alkylene oxides having from 2 to 4 carbon atoms in the alkylene moiety.

Examples of suitable alkylene oxides are tetrahydrofuran, 1,3-propylene oxide, 1,2- and 2,3-butylene oxide, styrene oxide and preferably ethylene oxide and 1,2-propylene oxide. The alkylene oxides may be used individually, alternatively one after the other, or as mixtures. Examples of suitable initiator molecules are water, organic dicarboxylic acids such as succinic acid, adipic acid, phthalic acid and terephthalic acid, and a variety of amines, including but not limited to aliphatic and aromatic, unsubstituted or N-mono-, N,N- and N,N′-dialkyl-substituted diamines having from 1 to 4 carbon atoms in the alkyl moiety, such as unsubstituted or mono- or dialkyl-substituted ethylenediamine, diethylenetriamine, triethylenetetramine, 1,3-propylene-diamine, 1,3- and 1,4-butylene diamine, 1,2-, 1,3-, 1,4-, 1,5- and 1,6-hexamethylenediamine, aniline, cyclohexanediamine, phenylenediamines, 2,3-, 2,4-, 3,4-and 2,6-tolylenediamine and 4,4′-, 2,4′- and 2,2′-diaminodiphenylmethane.

Other suitable initiator molecules are alkanolamines, e.g., ethanolamine, N-methyl- and N-ethylethanolamine, dialkanolamines, e.g., diethanolamine, N-methyl- and N-ethyldiethanolamine, and trialkanolamines, e.g., triethanolamine, and ammonia, and polyhydric alcohols, in particular dihydric and/or trihydric alcohols, such as ethanediol, 1,2- and 1,3-propanediol, diethylene glycol, dipropylene glycol, 1,4-butanediol, 1,6-hexanediol, glycerol, trimethylolpropane, pentaerythritol, sorbitol and sucrose, polyhydric phenols, for example, 4,4′-dihydroxydiphenylmethane and 4,4′-dihydroxy-2,2-diphenylpropane, resols, for example, oligomeric products of the condensation of phenol and formaldehyde, and Mannich condensates of phenols, formaldehyde and dialkanolamines, and melamine.

It is advantageous in some embodiments that the polyols included in the polyol system are polyether-polyols having a functionality of from 2 to 8 and a hydroxyl number of from 100 to 850 prepared by anionic polyaddition of at least one alkylene oxide, preferably ethylene oxide or 1,2-propylene oxide or 1,2-propylene oxide and ethylene oxide, onto, as initiator molecule, at least one aromatic compound containing at least two reactive hydrogen atoms and containing at least one hydroxyl, amino and/or carboxyl group. Examples which may be mentioned of such initiator molecules are aromatic polycarboxylic acids, for example, hemimellitic acid, trimellitic acid, trimesic acid and preferably phthalic acid, isophthalic acid and terephthalic acid, or mixtures of at least two said polycarboxylic acids, hydroxycarboxylic acids, for example, salicylic acid, p- and m-hydroxybenzoic acid and gallic acid, aminocarboxylic acids, for example, anthranilic acid, m- and p-aminobenzoic acid, polyphenols, for example, resorcinol, and preferably dihydroxydiphenylmethanes and dihydroxy-2,2-diphenylpropanes, Mannich condensates of phenols, formaldehyde and dialkanolamines, preferably diethanolamine, and preferably aromatic polyamines, for example, 1,2-, 1,3- and 1,4-phenylenediamine and in particular 2,3-, 2,4-, 3,4- and 2,6-tolylenediamine, 4,4′-, 2,4′-and 2,2′-diamino-diphenylmethane, polyphenyl-polymethylene-polyamines, mixtures of diamino-diphenylmethanes and polyphenyl-polymethylene-polyamines, as formed, for example, by condensation of aniline with formaldehyde, and mixtures of at least two of said polyamines.

The preparation of polyether-polyols using at least difunctional aromatic initiator molecules of this type is known and described in, for example, DD-A-290 201; DD-A-290 202; DE-A-34 12 082; DE-A-4 232 970; and GB-A-2,187,449.

The polyether-polyols preferably have a functionality of from 3 to 8, in particular from 3 to 7, and hydroxyl numbers of from 120 to 770, in particular from 200 to 650.

Other suitable polyether-polyols are melamine/polyether-polyol dispersions as described in EP-A-23 987 (U.S. Pat. No.4,293,657), polymer/polyether-polyol dispersions prepared from polyepoxides and epoxy resin curing agents in the presence of polyether-polyols, as described in DE 29 43 689 (U.S. Pat. No. 4,305,861), dispersions of aromatic polyesters in polyhydroxyl compounds, as described in EP-A-62 204 (U.S. Pat. No. 4,435,537) and DE-A 33 00 474, dispersions of organic and/or inorganic fillers in polyhydroxyl compounds, as described in EP-A-11 751 (U.S. Pat. No. 4,243,755), polyurea/polyether-polyol dispersions, as described in DE-A-31 25 402, tris(hydroxyalkyl) isocyanurate/polyether-polyol dispersions, as described in EP-A-136 571 (U.S. Pat. No. 4,514,426), and crystallite suspensions, as described in DE-A-33 42 176 and DE-A-33 42 177 (U.S. Pat. No. 4,560,708). Other types of dispersions that may be useful in the present invention include those wherein nucleating agents, such as liquid perfluoroalkanes and hydrofluoroethers, gases such as nitrogen, and inorganic solids, such as unmodified, partially modified and modified clays, including, e.g., spherical silicates and aluminates, flat laponites, montmorillonites and vermiculites, and particles comprising edge surfaces, such as sepiolites and kaolinite-silicas. Organic and inorganic pigments and compatibilizers, such as titanates and siliconates, may also be included in useful polyol dispersions.

Like the polyester-polyols, the polyether-polyols may be used individually or in the form of mixtures. Furthermore, they may be mixed with the graft polyether-polyols or polyester-polyols and the hydroxyl-containing polyester-amides, polyacetals, polycarbonates and/or phenolic polyols.

Examples of suitable hydroxyl-containing polyacetals are the compounds which may be prepared from glycols, such as diethylene glycol, triethylene glycol, 4,4′-dihydroxyethoxydiphenyldimethylmethane, hexanediol and formaldehyde. Suitable polyacetals can also be prepared by polymerizing cyclic acetals.

Suitable hydroxyl-containing polycarbonates are those of a conventional type, which can be prepared, for example, by reacting diols, such as 1,3-propanediol, 1,4-butanediol and/or 1,6-hexanediol, diethylene glycol, triethylene glycol or tetraethylene glycol, with diaryl carbonates, e.g., diphenyl carbonate, or phosgene.

The polyester-amides include, for example, the predominantly linear condensates obtained from polybasic, saturated and/or unsaturated carboxylic acids or anhydrides thereof and polyhydric, saturated and/or unsaturated amino alcohols, or mixtures of polyhydric alcohols and amino alcohols and/or polyamines.

Suitable compounds containing at least two reactive hydrogen atoms are furthermore phenolic and halogenated phenolic polyols, for example, resol-polyols containing benzyl ether groups. Resol-polyols of this type can be prepared, for example, from phenol, formaldehyde, expediently paraformaldehyde, and polyhydric aliphatic alcohols. Such are described in, for example, EP-A-0 116 308 and EP-A-0 116 310.

In certain preferred embodiments, the polyol system may include a mixture of polyether-polyols containing at least one polyether-polyol based on an aromatic, polyfunctional initiator molecule and at least one polyether-polyol based on a nonaromatic initiator molecule, preferably a trihydric to octahydric alcohol. As noted hereinabove, an amine-initiated polyol represents at least about 10 percent by weight of the polyol system.

The formulation of the invention also includes at least one physical blowing agent, which is necessary to both foam the formulation and which also desirably serves to enhance the thermal insulation capability of the final rigid polyurethane foam. Water, a chemical blowing agent, which forms carbon dioxide when reacted with an isocyanate, may also be included as a second blowing agent, in an amount not exceeding about 1.6 percent, based on the weight of the relatively high viscosity polyol system described hereinabove. Limitation of the amount of water serves to reduce the overall exotherm of the foam-forming reaction, while at the same time enhancing the thermal insulation and mechanical properties of the foam and its dimensional stability at low temperatures. Carbon dioxide may also be provided by means of adducts of CO₂, such as carbamates, may also be added to the foam formulations.

Among possible selections for the physical blowing agent are liquid CO₂, cycloalkanes including, in particular, cyclopentane, cyclohexane, and mixtures thereof; other cycloalkanes having a maximum of 4 carbon atoms; dialkyl ethers, cycloalkylene ethers, fluoroalkanes, and mixtures thereof. Specific examples of alkanes are, e.g., propane, n-butane, isobutane, n- and isopentane and technical-grade pentane mixtures, cycloalkanes, for example, cyclobutane, dialkyl ethers, for example, dimethyl ether, methyl ethyl ether, methyl butyl ether and diethyl ether, cycloalkylene ethers, for example, furan, and fluoroalkanes which are believed to be broken down in the troposphere and therefore are presently assumed to not damage the ozone layer, for example, trifluoromethane, difluoromethane, difluoroethane, tetrafluoroethane, and hepta-fluoropropane.

The physical blowing agents may, as noted hereinabove, be used alone or, preferably, in combination with water. The following combinations have proven highly successful and are therefore preferred: water and cyclopentane, water and cyclopentane or cyclohexane or a mixture of these cyclohexanes and at least one compound from the group consisting of n-butane, isobutane, n- and isopentane, technical-grade pentane mixtures, cyclobutane, methyl butyl ether, diethyl ether, furan, trifluoromethane, difluoromethane, difluoroethane, tetrafluoroethane, and heptafluoropropane. In particularly preferred embodiments, it is found that including at least one low-boiling compound therein, preferably having a boiling point below about 40° C., which is homogeneously miscible with cyclopentane or cyclohexane, wherein either or these or a mixture thereof is being used, may improve the overall foam and/or its processability. In particular embodiments the resultant mixture of all blowing agents desirably has a boiling point of below about 50° C., and preferably from about 30 to about 0° C. Such blowing agents are also described in, for example, EP-A-0 421 269 (U.S. Pat. No. 5,096,933).

Other suitable non-chlorofluorocarbon physical blowing agents are blowing agent-containing emulsions having a long shelf life, which contain at least one low-boiling, fluorinated or perfluorinated hydrocarbon having from 3 to 8 carbon atoms, which is sparingly soluble or insoluble in any of the required formulation components, sulfur hexafluoride or mixtures thereof, and at least one formulation component, as described in EP-A-0 351 614 or emulsions of mixtures of the abovementioned low-boiling, fluorinated or perfluorinated hydrocarbon having 3 to 8 carbon atoms which is sparingly soluble or insoluble in the formative components, and at least one isoalkane having 6 to 12 carbon atoms or cycloalkane having 4 to 6 carbon atoms or cycloalkane having 4 to 6 carbon atoms and at least one formative component, for example, as described in DE-A-41 43 148.

The requisite amount depends on the course of the boiling-point curve of the mixture and may be determined experimentally by known methods. However, in certain embodiments rigid polyurethane foams having desirable densities and low thermal conductivity may be obtained where the blowing agent is cyclopentane, in an amount from about 3 to about 22 parts by weight, preferably from 5 to 21, more preferably from 8 to 20, parts by weight, based on 100 parts of the polyol system, combined with water in an amount of from 0 to 1.6 parts by weight, preferably from 0.1 to 1.5 parts by weight, and particularly from 0.2 to 1.5 parts by weight, on the same basis. Where a low-boiling compound which is homogeneously miscible with both the cyclopentane or cyclohexane, is included, e.g., an alkane, such as iso-pentane or butane; cycloalkane having a maximum of 4 carbon atoms, dialkyl ether, cycloalkylene ether, fluoroalkane, or a mixture thereof. Such low-boiling compounds when used are present in an amount of from 0.1 to 18 parts by weight, preferably from 0.5 to 15 parts by weight, and in particular from 1.0 to 12 parts by weight, on the same basis. Examples of hydrofluorocarbon blowing agents include 245fa, 134a, 365mfc, 227a and combinations thereof. In order to produce the rigid polyurethane foams of the invention, the non-chlorofluorocarbon blowing agent(s), in combination with water, is/are introduced via known methods into at least one of the formulation components prior to initiation of the final foam-forming reaction. Introduction into such component may be carried out under pressure if desired. It is also possible to introduce the blowing agent or blowing agent mixture directly into the reaction mixture, expediently by means of a suitable mixing device.

In order to expedite the foam-forming reacting, both a blowing catalyst and a curing catalyst are preferably included in the formulation. While it is known that some catalysts may promote both blowing and curing (so-called “balanced” catalysts), such are conventionally differentiated by their tendency to favor either the urea (blow) reaction, in the case of the blowing catalyst, or the urethane (gel) reaction, in the case of the curing catalyst. In some non-limiting embodiments, a catalyst that technically may catalyze both blowing and curing may be selected for its less-favored tendency, e.g., curing, and combined with another catalyst directed more toward the other purpose, e.g., blowing, and vice versa.

Examples of suitable blowing catalysts that may tend to favor the urea (or water and isocyanate) reaction are short chain tertiary amines or tertiary amines containing at least an oxygen and may include bis-(2-dimethylaminoethyl)ether; pentamethyldiethylene-triamine, triethylamine, tributyl amine, N,N-dimethylaminopropylamine, dimethylethanolamine, N,N,N′,N′-tetra-methylethylenediamine, or urea. In one embodiment, a combination of bis(dimethylaminoethyl)ether in dipropylene glycol may be an effective blowing catalyst, for example, in a 70/30 weight percent ratio. Combinations of any of the above may also be selected.

Examples of suitable curing catalysts that may tend to favor the urethane or polyol and isocyanate (gel or string) reaction, include, generally, amidines, organometallic compounds, and combinations thereof. These may include, but are not limited to, amidines such as 1,8-diazabicyclo[5.4.0]undec-7-ene and 2,3-dimethyl-3,4,5,6-tetrahydropyrimidine, and their salts.

Organometallic compounds may include organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate. Bismuth salts of organic carboxylic acids may also be selected, such as, for example, bismuth octanoate. The organometallic compounds may be selected for use alone or in combinations, or, in some embodiments, in combination with one or more of the highly basic amines listed hereinabove.

Example of catalysts able to promote both blowing and curing reactions are cyclic tertiary amines or long chain amines containing several nitrogens such as dimethylbenzylamine, N-methyl-N-ethyl-, and N-cyclohexylmorpholine, N,N,N′,N′-tetramethylbutanediamine and -hexanediamine, bis(dimethylamino-propyl)urea, dimethylpiperazine, dimethylcyclohexylamine, 1,2-dimethyl-imidazole, 1-aza-bicyclo[3.3.0]octane, triethylenediamine (TEDA). In one embodiment, 1,4-diazabicyclo[2.2.2]octane (TEDA) is used.

Another class of catalysts for both blowing and curing reactions are alkanolamine compounds, such as triethanolamine, triisopropanolamine, N-methyl- and N-ethyldiethanolamine, and dimethylethanolamine may also be selected. Combinations of any of the above may also be effectively employed.

Examples of commercially available blowing, curing or blowing/curing catalyst include NIAX A-4, NIAX A6, POLYCAT 6,

POLYCAT 5, POLYCAT 8, Niax Al; POLYCAT 58, DABCO T, DABCO NE 300, TOYOCAT RX 20, DABCO DMDEE, JEFFCAT ZR 70, DABCOTM 33 LV, NIAX A-33, DABCO R-8020, NIAX TMBDA, POLYCAT 77, POLYCAT 6, POLYCAT 9, POLYCAT 15, JEFFCAT ZR 50, TOYOCAT NP, TOYOCAT F94, DABCO NEM, etc. POLYCAT and DABCO catalysts are available from Air Products; TOYOCAT catalysts are available from Tosho Corporation; NIAX Catalysts are available from Momentive Performance Material; and JEFFCAT catalysts are available from Huntsman.

Some of these catalysts being solids or crystals are dissolved in the proper solvent which can be polyol, water, blowing agent, DPG or any carrier compatible with the polyurethane foaming.

A third class of catalysts is the trimerization catalyst, able to promote reaction of isocyanate on itself, tris(dialkylaminoalkyl)-s-hexahydrotriazines such as 1,3,5-tris(N,N-dimethylaminopropyl)-s-hexahydrotriazine; DABCO TMR 30, DABCO K 2097; DABCO K15, Potassium acetate, potassium octoate; POLYCAT 41, POLYCAT 43, POLYCAT 46, DABCO TMR, CURITHANE 352, tetraalkylammonium hydroxides such as tetramethylammonium hydroxide; alkali metal hydroxides such as sodium hydroxide; alkali metal alkoxides such as sodium methoxide and potassium isopropoxide; and alkali metal salts of long-chain fatty acids having 10 to 20 carbon atoms and, in some embodiments, pendant hydroxyl groups. While these trimerization catalysts can be added to the other blowing and curing catalysts to boost foam reactivity, these are not required for the present invention. Some of these catalysts are solids or crystals and can be dissolved in the proper solvent which can be the polyol, water, blowing agent, dipropylene glycol or any other carrier with the polyurethane foaming composition.

In one particular embodiment, the combined amount of the blowing and curing catalysts, not considering the solvents, is greater than about 1.7 percent, based on the weight of the polyol system. In some embodiments, the combined amount of blowing and curing catalysts is 2 percent or greater of the polyol system. Generally the level of blowing and curing catalyst is less than 5 percent of the polyol system. The amount of catalyst can vary based on the temperatures of the materials.

In addition to the polyisocyanate, the relatively high viscosity polyol system, the non-chlorofluorocarbon blowing agent, the water, and the blowing and curing catalysts, the formulation may include additional, optional components. Among these may be chain extenders and/or crosslinking agents, which, unlike the polyols, are not polymers in their own right. Chain extenders are used to join together lower molecular weight polyurethane chains in order to form higher molecular weight polyurethane chains, and are generally grouped as having a functionality equal to 2. Crosslinking agents serve to promote or regulate intermolecular covalent or ionic bonding between polymer chains, linking them together to create a more rigid structure. The crosslinking agents are generally grouped as having a functionality equal to 3 or more. Both of these groups are usually represented by relatively short chain or low molecular weight molecules such as hydroquinone di(β-hydroxyethyl)ether, natural oil polyols (NOP) containing reactive hydroxyl groups, such as castor oil, glycerine, ethylene glycol (EG), diethylene glycol (DEG), triethylene glycol, tetraethylene glycol, propylene glycol, dipropylene glycol, tripropylene glycol, 1,3-propanediol, 1,3-butanediol, 1,4-butanediol (BDO), neopentyl glycol, 1,6-hexanediol, 1,4-cyclohexanedimethanol, ethanolamine, diethanolamine, methyldiethanolamine, phenyldiethanolamine, glycerol, trimethylolpropane (TMP), 1,2,6-hexanetriol, triethanol-amine,pentaerythritol, N,N,N′,N′-tetrakis(2-hydroxypropyl)-ethylenediamine, diethyl-toluenediamine, dimethylthiotoluenediamine, combinations thereof, and the like. Particularly frequently used are 1,4-butanediol (BDO), diethylene glycol (DEG), glycerine, 1,4-trimethylolpropane (TMP), and combinations thereof. Some molecules may contribute to both chain extension and crosslinking. Those skilled in the art will be familiar with a wide range of suitable chain extenders and/or crosslinking agents. When used, the crosslinker may be used in amount up to 8 wt % of the polyol.

Another optional additive is a surfactant, or a combination of surfactants. Inclusion of a surfactant in the formulation helps to emulsify the liquid components, regulate cell size, and stabilize the cell structure to prevent collapse and sub-surface voids. Suitable surfactants may include, but are not limited to, silicon-based compounds such as silicone oils and organosilicone-polyether copolymers, such as polydimethyl siloxane and polydimethylsiloxane-polyoxyalkylene block copolymers, e.g., polyether modified polydimethyl siloxane. Other suitable selections may include silica particles and silica aerogel powders, as well as organic surfactants such as nonylphenol ethoxylates and VORASURF^{TM} 504, which is an ethylene oxide/butylene oxide block co-polymer having a relatively high molecular weight. Many surfactant products sold under tradenames such as DABCO™ and TEGOSTAB™ may be useful in the inventive formulations.

Additional formulation components may optionally be included, according to the desire of the practitioner. Such may include pigments and colorants; flame retardants; antioxidants; surface modifiers; bioretardant agents; mold release agents; combinations thereof; and the like.

The formulation components may be combined and introduced into a mold or cavity in any way known in the art to produce a rigid polyurethane foam. In general, the relatively high viscosity polyol system component is first combined with the blowing agent, water, blowing and curing catalysts, crosslinkers and/or chain extenders, surfactant, and any additional additives to form a “B” side (in Europe, the “A” side), and this “B” side is then quickly contacted with the “A” side (in Europe, the “B” side), in order to begin the foaming and polymerization reactions. Proportionately the ratio of the two “sides” will generally be approximately 1:1 by volume in spray equipment, but an isocyanate index of from about 70 to about 500 is frequently conveniently employed; in some non-limiting embodiments, from about 80 to about 300; in other non-limiting embodiments, from about 90 to about 150; and in still other non-limiting embodiments, from about 100 to about 130. Those skilled in the art will be aware of various types of equipment to accomplish the contact while ensuring that an adequate level of mixing occurs to ensure uniformity of the final foam. One way to do this is to use a mixing injection head, wherein the two “sides” of the formulation are combined and mixed and then, more or less simultaneously, injected into the mold or cavity to be filled. The so-called “one shot” injection, wherein the mold or cavity is filled from a single injection point while simultaneously drawing a vacuum from another point, is particularly desirable. The vacuum may maximize mold- or cavity-filling prior to the formulation's desirably rapid gel time, which in particular embodiments may be less than about 25 seconds, and in other embodiments may be less than about 20 seconds. In some embodiments it may be less than about 15 seconds. The reduced gel time can be achieved by a balance of the catalyst concentration and the amount of amine initiated polyol. For example, by increasing the amount of amine initiated polyol, the total amount of blowing and curing catalyst can be reduced. Additional, increasing the amount of primary hydroxyl content or increasing the temperature of the reactants can decrease the gel time.

Desirably a reduced atmospheric pressure of from about 350 to about 850 millibars (mbar) may be employed, and more desirably from about 400 to about 800 mbar. (Atmospheric pressure is approximately 1013.25 mbar, or 101.325 kPa.) Art further describing application of a suitable reduced atmospheric pressure environment may be found in WO 2007/058793 Al; U.S. Pat. No. 5,972,260 A; WO 2006/013004 A1; WO 2006/013002 A1; and WO 2000/047384 A2. Where a mold is used, demolding may be carried out using standard methodologies, and where desirable, suitable external and/or internal mold release agents may be employed.

In another embodiment, the reactive foam-forming system is injected into a cavity at or above atmospheric pressure and a vacuum is then applied to the mold. In a further embodiment, the degree of vacuum may also be varied during the foaming process.

The formulation and process of the invention may be used to produce fine-celled, rigid polyurethane foams having a density of less than about 40 kg/m³; in certain embodiments it is less than about 38 kg/m³; and in other embodiments it is less than about 36 kg/m³. Density is measured according to ASTM 1622-88. For pipe in pipe applications, the molded density will generally greater than 40 kg/m³ and may generally in the range of 60 to 90 kg/m³. The cells may, in certain non-limiting embodiments, be at least about 70 percent closed; in other non- limiting embodiments, at least about 80 percent closed; and in still other non-limiting embodiments, at least about 85 percent closed. The foams may also, in certain non-limiting embodiments, exhibit an average cell diameter of less than about 250 microns, and in some embodiments less than about 200 microns, and a thermal conductivity of less than about 19 mW/mK at 10° C. average plate temperature, according to ISO 12939/DIN 52612. In some embodiments, a thermal conductivity of less than about 18.5 mW/mK at 10° C. average plate temperature may be achieved. Such foams may be particularly useful for both molded and cavity-filling applications, such as in appliance insulating walls for uses such as, non-limiting embodiments, refrigerators, freezers, and hot water storage tanks.

The description hereinabove is intended to be general and is not intended to be inclusive of all possible embodiments of the invention. Similarly, the examples herein-below are provided to be illustrative only and are not intended to define or limit the invention in any way. Those skilled in the art will be fully aware that other embodiments, within the scope of the claims, will be apparent, from consideration of the specification and/or practice of the invention as disclosed herein. Such other embodiments may include selections of specific isocyanates, polyols, physical blowing agents, and catalysts; selection of chain extenders and/or cross-linkers; selection of additives and adjuvants; mixing and reaction conditions, vessels, and protocols; performance and selectivity; variations in scale, including laboratory and commercial applicability; identification of products and by-products; and the like; and those skilled in the art will recognize that such may be varied within the scope of the claims appended hereto.

### EXAMPLE 1 (Comparative)

Formulation:

Isocyanate (“A-side”)

Voratec SD 100 A polymeric MDI with an NCO content of approximately 31% available from The Dow Chemical Company.

Polyol System (“B-side”)

Voratec SD 308 A formulated polyol with a hydroxyl number of 385 mg

KOH/g, a viscosity at 25° C. of 3500 mPa.s and a water content of 2.3%, containing 5 wt % of an amine initiated polyol and 1.4 wt % of a blowing and curing catalyst, commercially available from The Dow Chemical Company.

Voranol RN 482 Propoxylated sorbitol with a hydroxyl number of 480 mg KOH/g, available from The Dow Chemical Company.

Voranol CP 1055 Propoxylated glycerol with a hydroxyl number of 156 mg KOH/g, available from The Dow Chemical Company.

Voranol RA 500 Propoxylated ethylenediamine with a hydroxyl number of 500 mg KOH/g, available from The Dow Chemical Company.

Stepanpol PS 3152 Aromatic polyester polyol available from Stepan Chemical and having a hydroxyl number of 315 mg KOH/g.

Tercarol 5903 Propoxylated toluenediamine with a hydroxyl number of 440 mg KOH/g, available from The Dow Chemical Company.

Glycerol Triol with a hydroxyl number of 1828 mg KOH/g.

Polyol A Propoxylated 1,2-cyclohexanediamine with a hydroxyl number of 440 mg KOH/g.

Polyol B Polyester polyol with a hydroxyl number of 270 mg

KOH/g, made from phthalic anhydride, glycerine and diethleneglycol.

Additional Formulation Components

Curitane 206 an amine catalyst available from The Dow Chemical Company.

Pmdeta A blowing amine catalyst available from, e.g., Air Products & Chemicals Inc. (N,N,N′,N′,N-pentamethyldiethylenetriamine) as Polycat 5.

Dmcha An amine catalyst with blowing and curing characteristics available from, e.g., Air Products & Chemicals Inc. (Dimethylcyclohexylamine) as Polycat 8.

Dabco TMR-30 A trimerization catalyst available from Air Products & Chemicals Inc.

Dabco K2097 A trimerization catalyst available from Air Products & Chemicals Inc.

Polycat 41 A trimerzation catalyst (ris(dimethylaminopropyl)-s-hexahydrotriazine) available from Air Product & Chemicals.

Silicone-A A rigid foam surfactant available from Momentive.

Silicone-B A rigid foam surfactant available from Evonik.

Cyclopentane 95% cyclopentane available from Halterman.

Four example foams (designated as 1-4), and one comparative foam (designated as “Control Foam 1”), are prepared using the formulation amounts shown in Table 1. A high pressure Cannon machine equipped with a mix-head is attached to a mold injection hole, in a laboratory where the atmospheric pressure is about 1,000 mbar. This mold/mixhead connection is air-tight. The polyol system and additional formulation components are premixed and then injected, simultaneously with the isocyanate component, into a Brett mold at a mix-head pressure of at least 90 mbar. The temperature of the components is kept at 20° C. +/−2° C. The output of the machine is typically from about 150 to about 250 grams per second. The Brett mold is made of aluminum with dimensions of 200×20×5 cm and has no venting, which allows the creation of a reduced atmospheric pressure in the mold during foaming. Thus, there is no extrusion of the foaming mass. The internal pressure of the mold is controlled via a pipe connected to a 500 liter buffer tank that is connected to a medium capacity vacuum pump (1500 1/min). The vacuum in the buffer tank, and thus the in-mold air pressure, is maintained with control valves. The foams produced in this Brett mold are typically are used to measure thermal conductivity (also termed “lambda”), compression strength, molded density, and density distribution. The temperature of the mold is about 45° C. Typical demold-time of the foams is in the range of from about 8 to about 10 minutes. A release agent is applied to the mold prior to filling in order to facilitate demolding.

Foam samples are cut from the core of the molded part 24 hours after foam production and these samples are used for testing immediately after cutting. Lambda, i.e., thermal conductivity, is measured at 10° C. (average plate temperature) according to ISO 12939-01/ DIN 52612, using a Lasercomp FOX 200. Molded foam density and free rise foam densities are measured according to ASTM 1622-88. Foam compressive strength in kPa is measured according to DIN 53421-06-84. Values reported are an average of five (5) samples taken from various positions of the Brett mold.

Some other parameters determined during the foaming experiments are:

Free Rise Density: The density measured from a 100×100×100 mm block obtained from the center of a free-rising foam (at ambient air pressure) produced from a total system formulation weight of 300 grams or more. FRD is reported in kg/m³.

Foam Reactivity: The foam reactivity is determined on free-rise foams, using a 20×20×20 cm mold, with a shot-weight of 200 grams. From these foams, made at ambient pressure, cream-time, gel-time and tack-free time are determined.

Cream time is the time lapse in seconds from the beginning of the mixing process until a visual change of the reactants (cloudiness) occurs.

Gel time is the time in seconds from the beginning of the mixing process until a string can be pulled from the rising foam using a tongue depressor.

Tack free time: is the time in seconds from the beginning of the mixing process until the top foam surface is not sticky to the finger of the operator.

Polyol System viscosity is the viscosity of the fully formulated polyol, without the blowing agent, is measured according to ASTM D445 in mPa.s at 25 deg C.

Minimum Fill Density: The density determined from the minimum weight needed to fill the mold completely and the volume of this mold. MFD may be extrapolated from Brett mold length if the Brett mold is filled by more than 95 percent. MFD is reported in kg/m³.

Molded Density The density determined from the injected weight in the mold and the volume of this mold. MD is reported in kg/m³. The measured molded density is determined from the average of at least 5 samples of 100×100×“thickness” in mm (including skin) by weighing the samples and dividing the weight of each sample by the sample's measured volume.

Overpack The overpack is defined as [Molded density×100/Minimum Fill Density]. Overpack is reported in percent and has a typical value of 10-25 percent, depending on the physical blowing agent and the applied in-mold pressure.

Pressure The pressures described in this invention may be either air pressures on the foam, air pressure inside the mold cavity or foam mass pressure on the mold. All pressures are reported in absolute pressure, with the unit millibars (mbar) or kilopascals (kPa).

TABLE 1

| | Control | | | | |
|---|---|---|---|---|---|
| | Foam 1 | 1 | 2 | 3 | 4 |
| VORATEC SD 308 | 100 | 0 | 0 | 0 | 0 |
| TERCAROL | 0 | 19.9 | 19.9 | 19.9 | 19.9 |
| 5903 | | | | | |
| STEPANPOL PS | 0 | 15 | 15 | 15 | 15 |
| 3152 | | | | | |
| VORANOL | 0 | 14 | 14 | 14 | 14 |
| RN 482 | | | | | |
| VORANOL CP | 0 | 11.8 | 11.8 | 11.8 | 11.8 |
| 1055 | | | | | |
| Glycerol | 0 | 2.5 | 2.5 | 2.5 | 2.5 |
| Polyol-A | 0 | 30 | 30 | 30 | 30 |
| Silicone-A | 0 | 2.5 | 2.5 | 2.5 | 2.5 |
| Pmdeta | 0 | 1.2 | 1.2 | 1.2 | 1.2 |
| Dmcha | 0 | 1.1 | 1.1 | 1.1 | 1.1 |
| Dabco TMR30 | 0 | 0.5 | 0.5 | 0.5 | 0.5 |
| Dabco K 2097 | 0 | 0.2 | 0.2 | 0.2 | 0.2 |
| Water | 0 | 1.5 | 1.5 | 1.5 | 1.5 |
| Polyol | 3300 | 8000 | 8000 | 8000 | 8000 |
| System | | | | | |
| Viscosity | | | | | |
| (25° C.) | | | | | |
| Cyclopentane | 13 | 16 | 16 | 16 | 16 |
| Voratec | 145 | 135 | 135 | 135 | 135 |
| SD 100 Iso | | | | | |

TABLE 2

| | | | | | |
|---|---|---|---|---|---|
| Cream Time | 3 | 2 | 2 | 2 | 2 |
| (seconds) | | | | | |
| Gel Time | 43 | 15 | 15 | 15 | 15 |
| (seconds) | | | | | |
| Tack-free | 62 | 18 | 18 | 18 | 18 |
| Time | | | | | |
| (seconds) | | | | | |
| Free Rise | 22.0 | 22.8 | 22.8 | 22.8 | 22.8 |
| Density | | | | | |
| (kg/m³) | | | | | |
| Pressure in | 1.0 | 0.95 | 0.75 | 0.75 | 0.55 |
| mold (mbar) | | | | | |
| Minimum | 29.6 | 35.1 | 28.9 | 28.9 | 23.3 |
| Fill | | | | | |
| Density | | | | | |
| (kg/m³) | | | | | |
| Molded | 33.3 | 40.4 | 33.4 | 36.4 | 36.4 |
| Density | | | | | |
| (kg/m³) | | | | | |
| Compressive | 133 | 151 | 96 | 143 | 117 |
| Strength | | | | | |
| (kPa) | | | | | |
| Lambda | 20.0 | 18.6 | 17.9 | 18.3 | 18.4 |
| (10° C.) | | | | | |

### EXAMPLE 2 (Comparative)

A second series of foams are prepared, using the components, general conditions, and equipment as used in Example 1. However, alterations from that example are employed, as shown in Table 3, and testing results for this series of foams (designated as Control Foam 2, and example foams 5 and 6) are shown in Table 4.

TABLE 3

| | Control | | |
|---|---|---|---|
| | Foam 2 | 5 | 6 |
| VORATEC SD | 100 | 0 | 0 |
| 308 | | | |
| TERCAROL | 0 | 19.9 | 19.9 |
| 5903 | | | |
| VORANOL RN | 0 | 20 | 20 |
| 482 | | | |
| VORANOL RA | 0 | 10.5 | 10.5 |
| 500 | | | |
| VORANOL CP | 0 | 10 | 10 |
| 1055 | | | |
| Glycerol | 0 | 3 | 3 |
| Polyol-B | 0 | 29 | 29 |
| Silicone-B | 0 | 2.5 | 2.5 |
| Pmdeta | 0 | 1.5 | 1.5 |
| Dmcha | 0 | 1.5 | 1.5 |
| Dabco TMR30 | 0 | 0.7 | 0.7 |
| Water | 0 | 1.1 | 1.1 |
| Polyol | 3300 | 7000 | 7000 |
| System | | | |
| Viscosity | | | |
| (25° C.) | | | |
| Cyclopentane | 13 | 18 | 18 |
| Voratec | 145 | 130 | 130 |
| SD 100 Iso | | | |

TABLE 4

| | | | |
|---|---|---|---|
| Cream Time | 3 | 3 | 3 |
| (seconds) | | | |
| Gel Time | 43 | 17 | 17 |
| (seconds) | | | |
| Tack-free | 62 | 19 | 19 |
| Time | | | |
| (seconds) | | | |
| Free Rise | 22.0 | 22.7 | 22.7 |
| Density | | | |
| (kg/m³) | | | |
| Pressure in | 1.0 | 1.0 | 0.8 |
| mold (mbar) | | | |
| Minimum | 29.6 | 35.5 | 29.6 |
| Fill | | | |
| Density | | | |
| (kg/m³) | | | |
| Molded | 33.3 | 41.1 | 35.5 |
| Density | | | |
| (kg/m³) | | | |
| Compressive | 133 | 129 | 106 |
| Strength | | | |
| (kPa) | | | |
| Lambda | 20.0 | 18.1 | 18.0 |
| (10° C.) | | | |

### EXAMPLE 3 (Comparative)

A series of foams are prepared, using the components as given in Table 5. The foams are prepared in a Jumbo mold (70×35×10 cm) . Post-expansion of foam is measured after 24 hours on foams using different demold-times. Post-expansion is a measure of demold performance. The properties of the produced foams are given in Table 6.

TABLE 5

| | Control | | |
|---|---|---|---|
| | Foam 3 | 9 | 10 |
| VORATEC SD | 100 | 0 | 0 |
| 308 | | | |
| TERCAROL | 0 | 40 | 60 |
| 5903 | | | |
| VORANOL RN | 0 | 26 | 12.2 |
| 482 | | | |
| Stepanpol PS | 0 | 15 | 17 |
| 3152 | | | |
| VORANOL CP | 0 | 9.5 | 0 |
| 1055 | | | |
| Glycerol | 0 | 2.6 | 3.5 |
| Silicone-A | 0 | 2.5 | 0 |
| Silicone-B | 0 | 0 | 2.8 |
| Pmdeta | 0 | 1.5 | 2.7 |
| Dmcha | 0 | 1.0 | 0 |
| Dabco TMR30 | 0 | 0.5 | 0 |
| Polycat 41 | 0 | 0 | 0.7 |
| Curithane | 0 | 0.2 | 0 |
| 206 | | | |
| Water | 0 | 1.2 | 1.1 |
| Cyclopentane | 14 | 16 | 17 |
| Voratec | 145 | 135 | 139 |
| SD 100 Iso | | | |

TABLE 6

| | | | |
|---|---|---|---|
| Cream Time | 4 | 2 | 3 |
| (seconds) | | | |
| Gel Time | 42 | 21 | 13 |
| (seconds) | | | |
| Tack-free | 55 | 25 | 14 |
| Time | | | |
| (seconds) | | | |
| Free Rise | 22.0 | 23.8 | 23.4 |
| Density | | | |
| (kg/m³) | | | |
| Pressure | 1.0 | 0.8 | 0.8 |
| in mold | | | |
| (mbar) | | | |
| Lambda | 20.0 | 18.4 | 17.5 |
| (10° C.) | | | |
| Closed | 91.9 | 95.5 | 96.1 |
| Cells (%) | | | |
| Molded | 35.0 | 35.5 | 35.6 |
| Density | | | |
| (kg/m³) | | | |
| Post | \acute{ }— | 8.3 | 5.2 |
| expansion | | | |
| DMT = 3 | | | |
| minutes | | | |
| (mm) | | | |
| Post- | 8.3 | 6.8 | 4.5 |
| expansion | | | |
| DMT = 4 | | | |
| minutes | | | |
| (mm) | | | |
| Post- | 7.0 | 6.0 | 3.7 |
| expansion | | | |
| DMT = 5 | | | |
| minutes | | | |
| (mm) | | | |
| Post- | 5.9 | 5.2 | 2.9 |
| expansion | | | |
| DMT = 6 | | | |
| minutes | | | |
| (mm) | | | |
| Post- | 5.4 | \acute{ }— | \acute{ }— |
| expansion | | | |
| DMT = 7 | | | |
| minutes | | | |
| (mm) | | | |

The results indicate improved thermal conductivity of the foam and enhanced demold time performance indicated by the lower expansion values for examples 9 and 10.

1. A process for preparing a cavity-filling closed cell rigid polyurethane foam comprising
(a) preparing a reactive foam-forming system comprising as components at least
a polyisocyanate;
a polyol system containing at least 10 percent by weight of an amine-initiated polyol and having a viscosity of at least 5,000 cP at 25° C., according to ASTM D445;
a non-chlorofluorocarbon physical blowing agent;
a blowing catalyst;
a curing catalyst; and, optionally,
an amount of water that is less than 1.6 percent by weight based on the polyol system;
(b)injecting the reactive foam-forming system under a reduced atmospheric pressure into a cavity, wherein the reactive foam-forming system forms a gel in no more than 25 seconds; and
(c) maintaining the reduced atmospheric pressure at least until the gel forms a closed cell rigid polyurethane foam, the foam having a density of less than about 40 kg/m³, an average cell diameter of less than 250 microns, and a thermal conductivity of less than 19 mW/mK at 10° C. average plate temperature, according to ISO 12939/DIN 52612.

2. The process of claim 1 wherein the polyisocyanate is selected from the group consisting of 4,4′-, 2,4′- and 2,2′-diphenylmethane diisocyanate and the corresponding isomer mixtures; mixtures of 4,4′- and 2,4′-diphenylmethane diisocyanates; polyphenyl-polymethylene polyisocyanates; mixtures of 4,4′-, 2,4′-and 2,2′-diphenylmethane diisocyanates; and combinations thereof.

3. The process of claim 1 wherein the amine-initiated polyol is selected from the group consisting of mono- and dialkyl-substituted ethylenediamine; 1,2-, 1,3-, 1,4-, 1,5- and 1,6-hexamethylenediamine; aniline; 2,3-, 2,4-, 3,4- and 2,6-tolylenediamine; ethanolamine; diethanolamine; triethanolamine; and
combinations thereof.

4. The process of claim 1 wherein the non-chlorofluorocarbon physical blowing agent is selected from the group consisting of alkanes, cycloalkanes, hydrofluoroalkanes, and combinations thereof.

5. The process of claim 1 wherein the blowing catalyst is selected from the group consisting of bis-(2-dimethylaminoethyl)-ether; pentamethyldiethylenetriamine; triethylamine, tributyl amine, N,N-dimethylaminopropylamine, dimethylethanolamine, tetra-methylethylenediamine; and combinations thereof.

6. The process of claim 5 wherein the blowing catalyst is selected from the group consisting of bis-(2-dimethylaminoethyl)-ether, pentamethyldiethylenetriamine; and combinations thereof.

7. The process of claim 1 wherein the curing catalyst is selected from the group consisting of amidines; organometallic compounds; and combinations thereof.

8. The process of claim 7 wherein the curing catalyst is selected from the group consisting of 1,8-diazabicyclo[5.4.0]undec-7-ene; 2,3-dimethyl-3,4,5,6-tetrahydro-pyrimidine; tin(II) and dialkyltin(IV) salts of organic carboxylic acids; bismuth salts of organic carboxylic acids; and combinations thereof.

9. The process of claim 1 wherein the reduced atmospheric pressure ranges from about 350 to about 850 mbar.

10. The process of claim 1 wherein the density of the rigid polyurethane foam is less than about 38 kg/m³.

11. The process of claim 10 wherein the density of the rigid polyurethane foam is less than about 36 kg/m³.

12. The process of claim 1 wherein the viscosity of the polyol system is at least about 6,000 cP at 25° C., according to ASTM D445.

13. The process of claim 1 wherein the system gels at no more than about 20 seconds.

14. The process of claim 1 wherein the thermal conductivity at 10° C. average plate temperature is less than about 18.5 mW/mK, according to ISO 12939/DIN 52612.

15. The process of claim 1 wherein the total amount of blowing catalyst and curing catalyst together is greater than about 1.7 percent, based on the weight of the polyol system.

16. A process for preparing a cavity-filling closed cell rigid polyurethane foam comprising
(a) preparing a reactive foam-forming system comprising as components at least
a polyisocyanate;
a polyol system containing at least about 10 percent by weight of an amine-initiated polyol and having a viscosity of at least about 5,000 cP at 25° C., according to ASTM D445;
a non-chlorofluorocarbon physical blowing agent;
a blowing catalyst;
a curing catalyst; and, optionally, an amount of water that is less than about 1.6 percent by weight based on the polyol system;
(b) injecting the reactive foam-forming system at or above atmospheric pressure into a cavity, wherein the reactive foam-forming system forms a gel in no more than about 25 seconds
(c)subjecting the cavity to a reduced atmospheric pressure; and
(d)maintaining the reduced atmospheric pressure at least until the gel forms a closed cell rigid polyurethane foam, the foam having a density of less than about 40 kg/m³, an average cell diameter of less than about 250 microns, and a thermal conductivity of less than about 19 mW/mK at 10° C. average plate temperature, according to ISO 12939/DIN 52612.

17. The process of claim 1 wherein the blowing and curing catalyst is selected from the group consisting of dimethylbenzylamine, N-methyl-, N-ethyl-, and N-cyclohexylmorpholine, N,N,N′,N′-tetramethyl-butanediamine and -hexanediamine, bis(dimethylamino-propyl)urea, dimethylpiperazine, dimethylcyclohexylamine, 1,2-dimethyl-imidazole, 1-aza-bicyclo[3.3.0]octane, triethylenediamine, and combinations thereof.
